(19) United States
(12) Patent Application Publication
(10) Pub. No.: US 2004/0222645 A1
(43) Pub. Date: Nov. 11, 2004

(54) Magnetic lock device operated by means of transponder

(76) Inventors: Walter Pirone, Rieti (IT); Mauro Toni, Terni (Tr) (IT); Mauro Zenobi, Bastia Umbra (Pg) (IT)

Correspondence Address: PERKINS COIE LLP, BOX 2168, MENLO PARK, CA, 94025, US

(21) Appl. No.: 10/478,787

(22) PCT Filed: May 29, 2002
(86) PCT No.: PCT/IB02/01882

(30) Foreign Application Priority Data
May 29, 2001 (IT) B02001A000343

(51) Int. Cl. E05C 19/16

(52) U.S. Cl. 292/251.5

(57) ABSTRACT

A magnetic lock device operated by means of transponder is provided with at least an electromagnet mean (2) connected to a fixed portion (3) of a door (4) and with at least a keeper mean (5) fixed to the door (4) and, in a closing condition of this latter, facing the electromagnet mean (2). The device (1) includes: a control mean (6) for switching the electric supply of the electromagnet mean (2); a sensing mean (9) in data connection with the control mean (6) and fit to sense the proximity of a plurality of mobile transponders (10) each one associate to a respective operator. The control mean (6) is fit to interrupt the electric supply to the electromagnet mean (2) when the sensing means (9) senses the proximity of at least a transponder (10) and vice versa.

### TECHNICAL FIELD

The present invention relates to device for closing doors and the like. The invention refers to a magnetic lock device operated by means of transponder for controlling the opening of doors, wicket, porthole and generally of means for accessing rooms, containers, cells, freezers, biological incubators and the like particularly for laboratories, hospitals, chemical and pharmaceutical industries, and generally wherever it is necessary to enable and/or control the entrances.

### BACKGROUND ART

There are known devices for closing doors in which an electromagnetic mean, for instance an electromagnet, is connected to a fixed portion of a door frame and is electrically powered in order to magnetically stop an element made of ferromagnetic material, called keeper, fixed to the door.

The power supply of the electromagnet is commuted, switching on and off, by a local or remote, controlled by a mechanical keylock or a combination lock or a badge electronic lock.

The main drawback of these known devices consists in that the operator, in order to entering to the rooms closed by the door, must manually operate the lock for locking or unlocking the device with waste of time and potential risks for the material that the operator could transfer through the door.

### DISCLOSURE OF THE INVENTION

The main object of the present invention, is to propose a magnetic lock device operated by transponder which avoids the waits and operations of the operator qualified for the passage through the door having the lock device.

A further object is to propose a device fit to identify each person operating the device.

Other object is to propose a device whose operation can depend on the state of a plurality of its inputs and which is fit for controlling further means associates to the door.

Further object is to propose a device having connections with memory means.

Other object is to propose a device having a simple and low cost manufacturing and an easy and safe use.

The above-mentioned objects are achieved according with the content of the claims.

### BRIEF DESCRIEION OF TlE DRAWINGS

The characteristics of the invention are underlined in the following with particular reference to the attached drawings, in which:

FIG. 1 shows a schematic view of the magnetic lock device operated by means of transponder associated to a door;

FIG. 2 shows a partial top view of the device of FIG. 1, in which some parts have been removed for better underlining others.

### BEST MODE OF CARRYING OUT THE INVENTION

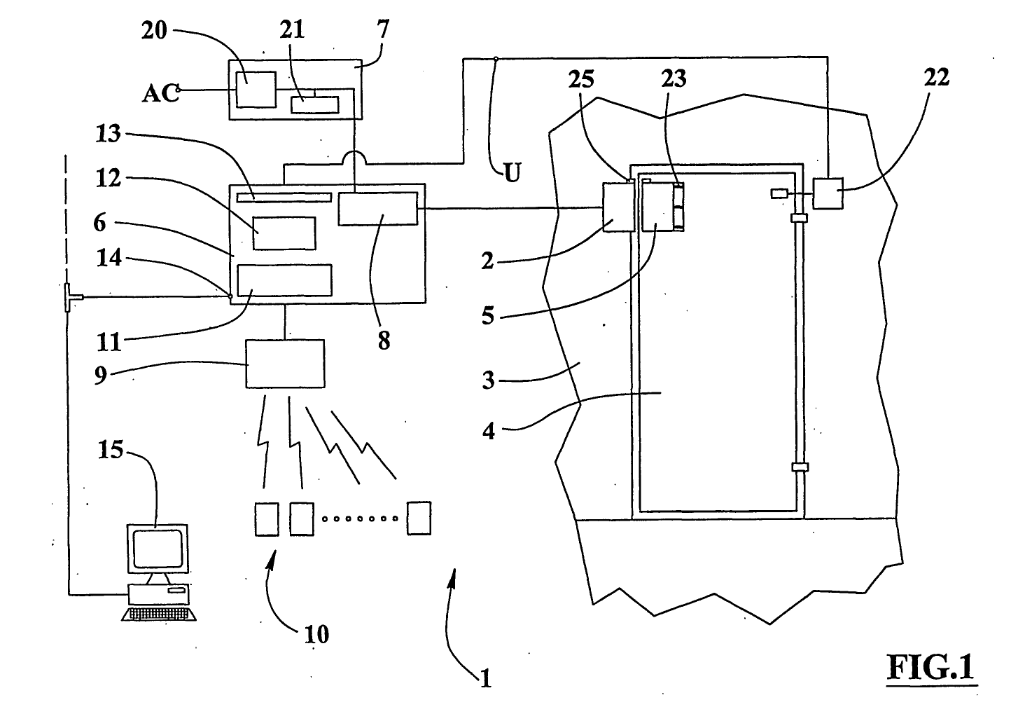

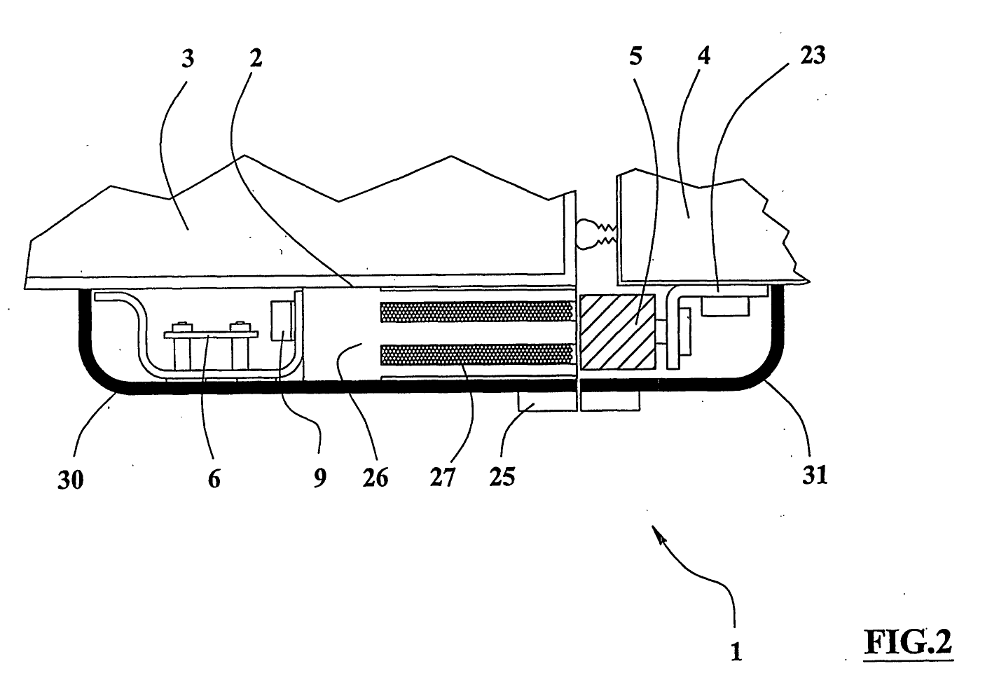

With reference to FIGS. 1 and 2, the numeral 1 indicates the magnetic lock device operated by means of transponder, object of the present invention.

The device 1 is associated to a door 4 having a fixed portion 3 consisting, for instance, in a frame or a building work.

The door 4, or porthole or wicket, allows the access to rooms, cells or containers reserved to predefined operators consisting of human staff or vehicles or other means.

The device 1 has an electromagnet mean 2, consisting of a magnetic core 26, having section approximately “E” shaped, oriented in direction of the keeper mean 5, and consisting of an electric winding 27, wrapped around the central leg of the magnetic core 26.

The electric winding 27 and the magnetic core 26 are enclosed in a layer of synthetic resin, which protects and reciprocally block these latter.

The magnetic core 26 is blocked to the fixed portion 3 and in a closing condition of the door 4, it faces a keeper mean 5, consisting for instance of a solid body made of ferromagnetic material fixed, through adjustable fixing means 23, to the edge of the door 4 opposed to the hinges. The minimum distance between the electromagnet 2 and the keeper mean 5 is adjustable through the adjustable fixing means 23.

The electric supply of the wrapping 27 of the electromagnet mean 2 is switched by a control mean 6.

This latter is in data connection with a sensing mean 9 provided with an antenna for sending electromagnetic signals for a plurality of transponders 10 and for receiving the answers of these latter. In a proximity condition of the transponders 10 to the sensing mean 9, this latter senses said answers. The proximity condition corresponds to an distance ranging between some centimetres, for instance in case of incubator or freezer counters, and some meters, for instance in case of room admittance doors, and it is eventually adjustable varying the sensibility of a receiver of the sensing mean 9. The transponders 10 are of passive type but it is provided that they can be of active type; in this last case the antenna of the sensing mean 9 only receives the sent signals by the active transponders 10.

The answers or the signals sent by the transponders 10 contain an identification code of each transponder. The correlation between the transponders 10 and the identification codes is biunique and since each operator qualified to the opening of the door 4 has his personal transponder 10, a correspondence biunique between operating and identification codes is established.

The sensing mean 9 senses said codes and transmits them to the control mean 6 that is of digital type including at least a microprocessor 12 and a memory unit 11 in which are stored the enabling codes corresponding to the identification codes of the qualified operators.

When the sensing mean 9 sends an identification code to the control mean 6, the microprocessor 12, executing a program stored for instance in a no-volatile memory of the memory unit 11, checks the possible correspondence of said code of identification with one of the qualification code.

If said correspondence is verified, the control mean 6 cuts off the electric supply to the electromagnet mean 2 which frees the keeper mean 5 allowing opening of the door 4.

The device 1 has opening sensor means 25 consisting in a magnetic contact of the type called reed, connected to the fixed portion 3, and in a related magnet fixed to the door 4 in such a way that, in the closing condition of this latter, the contact and the magnet are reciprocally facing. The contact is connected to the control mean 6, which senses the opening condition in correspondence of the opening of the said contact.

The device 1 is provided with supply means 7 including rectifier means 20, connected at the input to an alternate voltage AC supply mains and including electric energy battery 21 to provide energy to the control mean 6 and to the electromagnet mean 2, also in case of lack of electric supply.

The control mean 6 is provided with switch means 8, for instance consisting of an electromagnetic relay or in a bipolar transistor to connect the electromagnet mean 2 to the supply means 7 and therefore to supply or not the winding 27 of the electromagnet mean 2.

The control mean 6 is provided with alarm means 13, for instance consisting of a beeper or a light, for sending a signal in correspondence of the supply break condition of the electromagnet mean 2.

The control mean 6 has a connection port 14 for the connection to processing means 15, for instance a remote personal computer, in order to transmit to these latter the identification codes of the transponders 10, in a proximity condition to the sensing mean 9, the supply state of the electromagnet mean 5 and to receive the enabling codes to be inserted and/or erased into and from the memory 11.

The connection port 14 can be, for instance of Ethernet type or serial adressable of Universal Serial Bus standard, said USB, or of the serial RS 232 type or differential serial or parallel.

The control mean 6 can include a U connection for the operation of opening means 22, for instance including an electric linear actuator whose first end is connected to the fixed portion 3 and the second one is connected to the door 4, for opening this latter.

The control mean 6, the sensing mean 9 and the electromagnet mean 2 are internally connected to a first container 30 and the keeper mean 5, with the related adjustable fixing means 23, is fixed inside a second container 31.

The containers, first 30 and second 31 have shielding functions and are made of injected ABS, for instance.

It is also provided that the device 1 includes a plurality of control means 6 each one connected to respective sensing means 9 and to the electromagnet 2 associated to respective doors 4 each one provided with at least a keeper mean 5.

The operation provides that when at least a transponder 10, associated to a identification code corresponding to a qualification code, is in a proximity condition of the control mean 6, this last breaks off the supply of the electromagnet mean 2, allowing the opening of the door 4 or eventually opening this latter by the opening means 22.

The possible processing means 15 record, in association to the schedule of each event, the identification codes of the transponders 10 in the proximity condition and the supply state of the electromagnet means 2 and therefore the opening or the possibility of opening the door 4 or each door associated to the device.

The processing means 15 allow also to change the qualification codes permitting different operators to open the door 4.

The main advantage of the present invention is to provide a magnetic lock device operated by means of transponder fit to identify each operator and allowing the opening of the related door avoiding waits and operations of the operators qualified for the passage through said door.

Other object is to propose a device whose operation may depend on the state of a plurality of its inputs and which is fit for controlling further means associates to the door and provided with connections with memory means.

Other object is to propose a device having a simple and low cost manufacturing and an easy and safe use.

1) Magnetic lock device operated by means of transponder provided with at least a electromagnet mean (2) connected to a fixed portion (3) of a door (4) and with at least a: keeper mean. (5) fixed to the door (4) and, in a closing condition of this latter, facing the electromagnet mean (2) which, in an electric supply condition, magnetically attracts and blocks said keeper mean (5), said device (1) being characterized in that includes:
a control mean (6) for switching the electric supply of the electromagnet mean (2);
a sensing meani (9) in data connection with the control mcan (6) and fit. to sense the proixmity of a plurality of mobile transponders (10) each one associate to a respective operator;
the control mean (6) being fit for breaklng the electric power supply to the electromagnet mean
(2) when the sensing mean (9) senses the proximity of at least a transponder (10) and vice versa.

2) Device according to claim 1 characterized in that the control mean (6) is of digital type including at least a microprocessor (12) and a memory unit (11).

3 ) Device according to claim 2 characterized in that each transponder (10) is associated in a biunique way to a personal identification code which, in a proximity condition of the transponder (10) to the sensing mean (9), is sensed by this latter and transmitted to the control mean (6) that, in correspondence of the retrieval in its memory (11) of a corresponding enabling code, breaks the electric power supply of the electromagnet mean (2), allowing the opening of the door (4).

4) Device according to claim 1 characterized in that the control mean (6) has switching means (8) interposed between each electromagnet mean (2) and supply means (7) of the device (1).

5) Device according to claim 4 characterized in that the supply means (7) include rectifier means (20), connected to an alternate voltage AC supply mains, and electric energy battery means (21).

6) Device according to claim 1 characterized in that further includes opening sensor means (25) associated to the fixed portion (3) and to the door (4) and connected to the control mean (6) in order to sense an opening condition. of the door (4).

7-9. cancel

10) Device according to-claim 1 characterized in that the control mean (6) has-a connection port (14) for connecting processing means (15) for transrnitting to these latter at least the identification codes of the transponders (10) in a proximity condition to the sensing mean (9) and for receiving the enabling codes to be inserted and/or erased in the memory (1 1).

11) Device according to claim 10, characterized in that the connection port (14) is an Ethernet or USB or RS 232 or differential serial or parallel port.

12) Device according to claim I characterized in that the control mean (6) includes a connection (U). for operating opening means (22) connected to the door (4) for opening this latter in correspondence of a supply interruption condition of the electromagnet mean (2) and vice versa.

13-18. cancel

19. The device as recited in claim 1, wherein at least the control mean, the sensing mean and at least the electromagnet mean are fixed inside a first container.

20. The device as recited in claim 1, wherein at least the control mean, the sensing mean, and at least the electromagnet mean are fixed inside a first container.

21. The device as recited in claim 1, wherein each keeper mean is internally fixed to a second container.

22. The device as recited in claim 1, wherein the electromagnet mean is provided with a magnetic core approximately “E” shaped and with an electric winding wrapped around the central leg of the magnetic core.

23. The device as recited in claim 22, wherein the electric winding and the magnetic core are enclosed in a synthetic resin layer.

24. The device as recited in in claim 1, further including a plurality of control means each connected at least to respective sensing mean and electromagnetic mean associated to respective doors each provided with a least a keep mean.

25. The device as recited in claim 1, furtherincluding alarm means, wherein said alarm means includes a beeper or a light.

26. The device as recited in claim 6, wherein the control mean operated the alarm mean to generate light signals corresponding to a supply interruption condition of the electromagnetic mean.

27. The device as recited in claim 25, wherein the control mean operated the alarm mean to generate light signals corresponding to a supply interruption condition of the electromagnetic mean.

28. The device as recited in claim 25, wherein the control mean operates alarm means to generate signals corresponding to the opening condition of the door.
